(19) United States
(12) Patent Application Publication
(10) Pub. No.: US 2025/0290950 A1
(43) Pub. Date: Sep. 18, 2025

(54) High Frequency Passivated AFM Cantilever and Method of Fabrication

(71) Applicant: Bruker Nano, Inc., Santa Barbara, CA (US)

(72) Inventors: Rakesh Poddar, Camarillo, CA (US); Vladimir Zhizhimontov, Goleta, CA (US)

(21) Appl. No.: 19/080,323

(22) Filed: Mar. 14, 2025

Related U.S. Application Data
(60) Provisional application No. 63/565,362, filed on Mar. 14, 2024.

(51) Int. Cl. G01Q 60/38; G01Q 70/10; G01Q 70/16

(52) U.S. Cl. CPC G01Q 60/38; G01Q 70/10; G01Q 70/16

(57) ABSTRACT

A probe assembly for a surface analysis instrument such as an atomic force microscope (AFM), and a corresponding method of fabrication, the probe assembly including a substrate defining a probe body of the probe assembly, and a cantilever of the probe assembly extending from the probe body and having a proximal end and a free distal end. A reflective metal layer is disposed on the cantilever to reflect electromagnetic energy/light from a source (e.g., laser) of a deflection detection apparatus, and is a chemically non-inert metal. A passivating layer is disposed on the reflective layer to preserve the reflective layer when operating the surface analysis instrument to measure a sample in a reactive fluid. The passivating layer is deposited using pinhole free atomic layer deposition (ALD), and is at least one of silicon oxide (SiO2) and silicon nitride (Si3N4).

### CROSS-REFERENCE TO RELATED APPLICATION

This application claims priority under 35 U.S.C. § 1.119(e) to U.S. Provisional Patent Application No. 63/565,362, filed Mar. 14, 2024. The subject matter of this application is hereby incorporated by reference in its entirety.

### BACKGROUND OF THE INVENTION

### Field of the Invention

A probe assembly for a metrology instrument and a corresponding method of manufacture, and more particularly, a probe assembly having a metal coated cantilever with an ultrathin passivating film, preferably using Atomic Layer Deposition (ALD).

### Description of Related Art

Scanning probe microscopes (SPMs), such as the atomic force microscope (AFM), are devices which use a sharp tip and low forces to characterize the surface of a sample down to atomic dimensions. A radius of curvature of the sharp tip can be down to 1 nm given the current state of technology. Generally, the tip of the SPM probe is introduced to the sample surface to detect changes in the characteristics of the sample. By providing relative scanning movement between the tip and the sample, surface characteristic data can be acquired over a particular region of the sample and a corresponding map of the sample can be generated.

A typical AFM system is shown schematically in FIG. 1. An AFM 10 employs a probe device 12 including a probe 14 having a cantilever 15 extending from a base 19 and supporting a tip 17. Scanner 24 generates relative motion between the probe 14 and sample 22 while the probe-sample interaction is measured. In this way images or other measurements of the sample can be obtained. Scanner 24 is typically comprised of one or more actuators that usually generate motion in three orthogonal directions (XYZ). Often, scanner 24 is a single integrated unit that includes one or more actuators to move either the sample or the probe in all three axes, for example, a piezoelectric tube actuator. Alternatively, the scanner may be an assembly of multiple separate actuators. Some AFMs separate the scanner into multiple components; for example, an XY scanner that moves the sample and a separate Z-actuator that moves the probe. The instrument is thus capable of creating relative motion between the probe and the sample while measuring the topography or some other surface property of the sample as described, e.g., in Hansma et al. U.S. Pat. No. RE 34,489; Elings et al. U.S. Pat. No. 5,266,801; and Elings et al. U.S. Pat. No. 5,412,980.

In a common configuration, probe 14 is often coupled to an oscillating actuator or drive 16 that is used to drive probe 14 at or near a resonant frequency of cantilever 15. Alternative arrangements measure the deflection, torsion, or other motion of cantilever 15. Probe 14 is often a microfabricated cantilever with an integrated tip 17.

Commonly, an electronic signal is applied from an AC signal source 18 under control of an SPM controller 20 to cause actuator 16 (or alternatively scanner 24) to drive probe 14 to oscillate. The probe-sample interaction is typically controlled via feedback by controller 20. Notably, actuator 16 may be coupled to scanner 24 and probe 14 but may be formed integrally with cantilever 15 of probe 14 as part of a self-actuated cantilever/probe.

Often a selected probe 14 is oscillated and brought into contact with sample 22 as sample characteristics are monitored by detecting changes in one or more characteristics of the oscillation of probe 14, as described above. In this regard, a deflection detection apparatus 25 is typically employed to direct a beam towards the backside of probe 14, the beam then being reflected towards a detector 26. As the beam translates across detector 26, appropriate signals are processed at block 28 to, for example, determine RMS deflection and transmit the same to controller 20, which processes the signals to determine changes in the oscillation of probe 14. In general, controller 20 generates control signals to maintain a relative constant interaction between tip 17 and sample 22 (or deflection of cantilever 15), typically to maintain a setpoint characteristic of the oscillation of probe 14. More particularly, controller 20 may include a PI Gain Control block 32 and a High Voltage Amplifier 34 that condition an error signal obtained by comparing, with a circuit 30, a signal corresponding to probe deflection caused by tip-sample interaction with a setpoint. For example, controller 20 is often used to maintain the oscillation amplitude at a setpoint value, AS, to insure a generally constant force between tip 17 and sample 22. Alternatively, a setpoint phase or frequency may be used.

A workstation 40 is also provided, in controller 20 and/or in a separate controller or system of connected or stand-alone controllers, that receives the collected data from the controller and manipulates the data obtained during scanning to perform point selection, curve fitting, and distance determining operations.

AFMs may be designed to operate in a variety of modes, including contact mode and oscillating mode. Operation is accomplished by moving either the sample or the probe assembly up and down relatively perpendicular to the surface of the sample in response to a deflection of the cantilever of the probe assembly as it is scanned across the surface. Scanning typically occurs in an “x-y” plane that is at least generally parallel to the surface of the sample, and the vertical movement occurs in the “z” direction that is perpendicular to the x-y plane. Note that many samples have roughness, curvature and tilt that deviate from a flat plane, hence the use of the term “generally parallel.” In this way, the data associated with this vertical motion can be stored and then used to construct an image of the sample surface corresponding to the sample characteristic being measured, e.g., surface topography.

In an AFM, for example, in a mode of operation called contact mode, the microscope typically scans the tip, while keeping the force of the tip on the surface of the sample generally constant. This is accomplished by moving either the sample or the probe assembly up and down relatively perpendicular to the surface of the sample in response to a deflection of the cantilever of the probe assembly as it is scanned across the surface. In this way, the data associated with this vertical motion can be stored and then used to construct an image of the sample surface corresponding to the sample characteristic being measured, e.g., surface topography. Similarly, in another preferred mode of AFM operation, known as TappingMode™ (TappingMode™ is a trademark owned by the present assignee), the tip is oscillated at or near a resonant frequency of the associated cantilever of the probe. The amplitude or phase of this oscillation is kept constant during scanning using feedback signals, which are generated in response to tip-sample interaction. As in contact mode, these feedback signals are then collected, stored and used as data to characterize the sample.

The deflection of the cantilever in response to the probe tip's interaction with the sample is measured with a sensitive deflection detector, most often an optical lever system. In such optical systems, a lens is employed to focus energy, from a coherent electromagnetic energy source (e.g., laser, super luminescent diode (SLD), etc.) typically placed overhead of the cantilever, onto the back side of the cantilever. The backside of the lever (the side opposite the tip) is reflective (for example, using metallization during fabrication) so that the beam may be reflected therefrom towards a photodetector. The translation of the beam across the detector during operation provides a measure of the deflection of the lever, which again is indicative of one or more sample characteristics.

Aluminum and gold films are commonly used as coatings for silicon AFM probes due to their reflective properties, efficiently directing the optical deflection detection laser for tracking cantilever movement, thereby allowing the acquisition of an AFM image of the sample. Aluminum is cheaper and more reflective but it is not suitable for use in some biological buffers and solvents because of its instability and dissolution in the liquid environment. Therefore, a chemically inert material such as gold or platinum is often preferred for reflecting the laser energy in a submerged environment of potentially corrosive chemicals. Such a probe assembly for use in fluid is shown in FIG. 2. In this case, a probe assembly 50 includes a cantilever 52 extending from a probe base 54 and supporting a tip 56 at its distal end 58. Cantilever 52 includes a backside 60 upon which a reflective coating 62 such as gold is deposited.

However, gold and platinum being heavy metals have the tendency to reduce the cantilever resonance and thus bandwidth (i.e., imaging speed). In the end, gold being highly dense imposes a geometrical constraint on the ultra-high frequency cantilever. For instance, the cantilever length may be modified (e.g., made shorter) or its thickness may be increased to achieve the desired bandwidth. The problem in that case is that these geometric modifications can make the cantilevers stiff, which can create challenges in some AFM modes, especially when soft levers are needed (e.g., when imaging certain types of samples).

Alternatively, some AFMs employ active cantilevers in which the detection mechanism does not require a reflective metal surface. For example, active cantilevers such as that shown in FIG. 3 use piezo resistors at the base of the cantilever. A probe assembly 70 includes a cantilever 72 extending from a base 74 at a proximal end 76. Base 74 supports circuitry 77 for detecting cantilever deflection. Using microfabrication techniques, piezoresistive layers 78 are deposited to form one or more active piezo resistors 80, passive piezo resistors 82 and a ground trace 84, for example. Active piezo resistor 80 is preferably disposed at proximal end 76 of cantilever 72 to facilitate measuring probe deflection, with distal end 86 of cantilever 72 supporting a tip (not shown in FIG. 3). Device layer cutouts 88 result from the semiconductor fabrication process. In operation, the change in resistivity is measured as an indicator of cantilever motion which, in turn, is used to build an image of the sample surface, for example. Fabricating such active probe assemblies is expensive and entails a more complicated fabrication process. Complex fabrication can lead to low yield and high costs. Measurement accuracy is also impacted by ambient temperature variation, while feedthrough between cantilever actuation and sensing can cause increased noise and limited sensitivity.

In view of the above, the field of scanning probe microscopy was in need of a probe assembly that can accommodate AFM modes and systems that employ an optical beam bounce deflection detection scheme using a reflective layer suitable for use in a fluid environment that may include corrosive chemicals. Preferably, the probe design would incorporate a lighter metal reflective coating on the probe, such as aluminum.

Note that “SPM” and the acronyms for the specific types of SPMs, may be used herein to refer to either the microscope apparatus, or the associated technique, e.g., “atomic force microscopy.”

### SUMMARY OF THE INVENTION

The preferred embodiments overcome the drawbacks of prior solutions by providing a probe assembly design and corresponding method of manufacture that encapsulates a metal coated cantilever with an ultrathin passivating film, preferably using Atomic Layer Deposition (ALD) so that the film has no pinholes. Because the passivating film is ultra-thin and uniform, it does not have an appreciable effect on cantilever speed and stiffness.

According to a first aspect of the preferred embodiment, a probe assembly for a surface analysis instrument includes a substrate defining a probe body of the probe assembly, and a cantilever of the probe assembly extending from the probe body and having a proximal end and a free distal end. A reflective metal layer is disposed on the cantilever to reflect electromagnetic energy/light from a coherent source (e.g., laser) of a deflection detection apparatus, with the reflective metal layer preferably being a chemically non-inert metal, such as aluminum. A passivating layer is disposed on the reflective layer to preserve the reflective layer when operating the surface analysis instrument in a reactive fluid.

According to a further aspect of this preferred embodiment, the passivating layer is formed on the reflective layer using one of pinhole free atomic layer deposition (ALD), PECVD deposition or LPCVD deposition.

In another aspect of this embodiment, a tip extends from the distal free end of the cantilever, the tip being formed before the passivating layer is deposited on the probe assembly. In this case, a sharp tip is formed to extend from the tip after the passivating layer is deposited on the probe assembly. The sharp tip is preferably formed using electron beam deposition (EBD).

According to a still further aspect of the preferred embodiment, the tip is formed before the passivating layer is deposited on the probe assembly, and an apex of the tip is exposed using one of local etching and focused ion beam milling.

According to an alternate aspect of the preferred embodiment, the reflective metal layer is disposed on one of the frontside and backside of the probe assembly, and a second reflective metal layer is disposed on the other of the frontside and backside of the probe assembly. The second reflective metal layer is a chemically inert metal.

According to another aspect of this embodiment, the reflective metal layer is at least one of a stack of reactive metal layers and patterned metal layers.

In another aspect of this embodiment, the passivating layer is deposited on at least one of the frontside and the backside of the cantilever, and is at least one of Silicon Oxide (SiO₂) and Silicon Nitride (Si₃N₄).

In another embodiment, a method of manufacturing a probe assembly for a probe-based instrument includes providing a substrate and forming a probe body of the probe assembly from the substrate and a cantilever of the probe assembly extending from the probe body and having a proximal end and a free distal end. Next, the method includes depositing a reflective metal layer on the cantilever particularly suited to reflect light/electromagnetic energy from a coherent source (e.g., a laser) deflection detection apparatus, with the reflective metal layer being a chemically non-inert metal. Finally, a passivating layer is deposited on the reflective layer to preserve the reflective layer when operating the surface analysis instrument to measure a sample in a reactive fluid.

According to another aspect of this embodiment, the depositing a passivating layer step is performed using pinhole free atomic layer deposition (ALD), and the passivating layer is at least one of Silicon Oxide (SiO₂) and Silicon Nitride (Si₃N₄).

According to yet another aspect of this embodiment, the method includes microfabricating an array of the probe assemblies from the wafer.

In another aspect of this embodiment, the method includes forming a tip to extend from the distal end of the cantilever. The tip is formed before the passivating layer is deposited on the probe assembly, and a sharp tip is formed to extend from the tip after the passivating layer is deposited.

In another embodiment, a probe assembly for a surface analysis instrument includes a substrate defining a probe body of the probe assembly, and a cantilever extending from the probe body and having a proximal end and a free distal end. A reflective layer is disposed on the cantilever to reflect a light source beam from a deflection detection apparatus, and a passivating layer is disposed on the reflective layer. In this case, the passivating layer is formed on the reflective layer using pinhole free atomic layer deposition (ALD).

According to another aspect of this embodiment, the passivating layer operates to either protect the reflective layer from corrosion when operating the surface analysis instrument in fluid, or to prevent charge leakage during electrical or electro-chemical experiments in the fluid.

These and other objects, features, and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1 is a schematic illustration of a Prior Art atomic force microscope;

FIG. 2 is a schematic side elevation view of a Prior Art atomic force microscope (AFM) probe assembly, having a chemically inert metal deposited on the backside of its cantilever;

FIG. 3 is a schematic isometric view of a probe assembly of a Prior Art atomic force microscope (AFM) probe assembly with piezoresistive sensing elements, also known as an active probe;

FIGS. 4 is a schematic side elevational view of a probe assembly of preferred embodiment using atomic layer deposition (ALD) passivation;

FIGS. 5 is a schematic side elevational view of a probe assembly of another preferred embodiment using atomic layer deposition (ALD) passivation;

FIG. 6 is a schematic side elevational view of a probe assembly of another preferred embodiment using atomic layer deposition (ALD) passivation;

FIG. 7 is a schematic side elevational view of a probe assembly of a still further preferred embodiment using atomic layer deposition (ALD) passivation; and

FIG. 8 is a flow chart illustrating a method of fabricating a probe assembly of the preferred embodiments using atomic layer deposition (ALD) passivation.

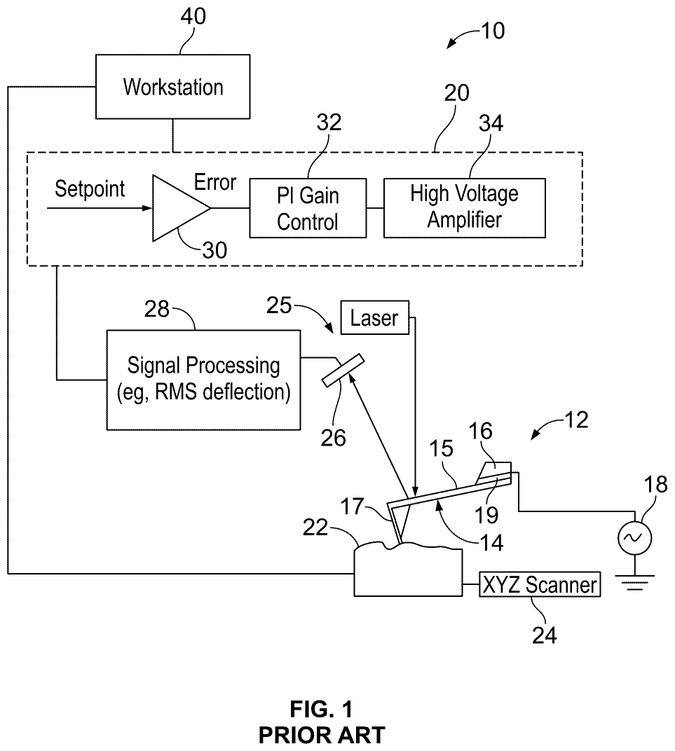

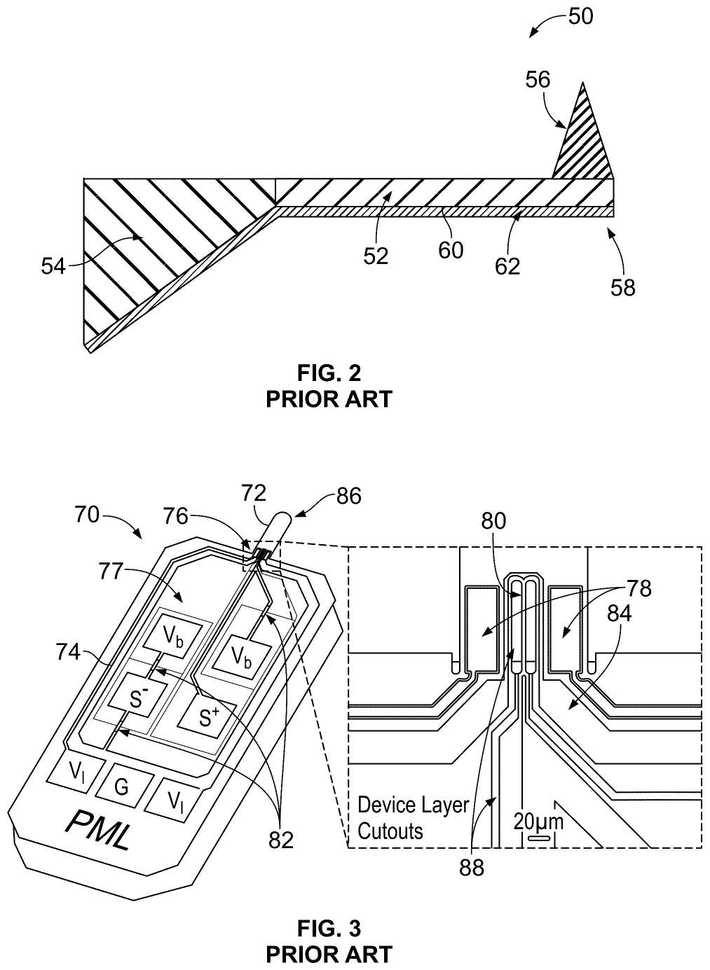

### DETAILED DESCRIPTION OF THE PREFERRED EMBODIMENTS

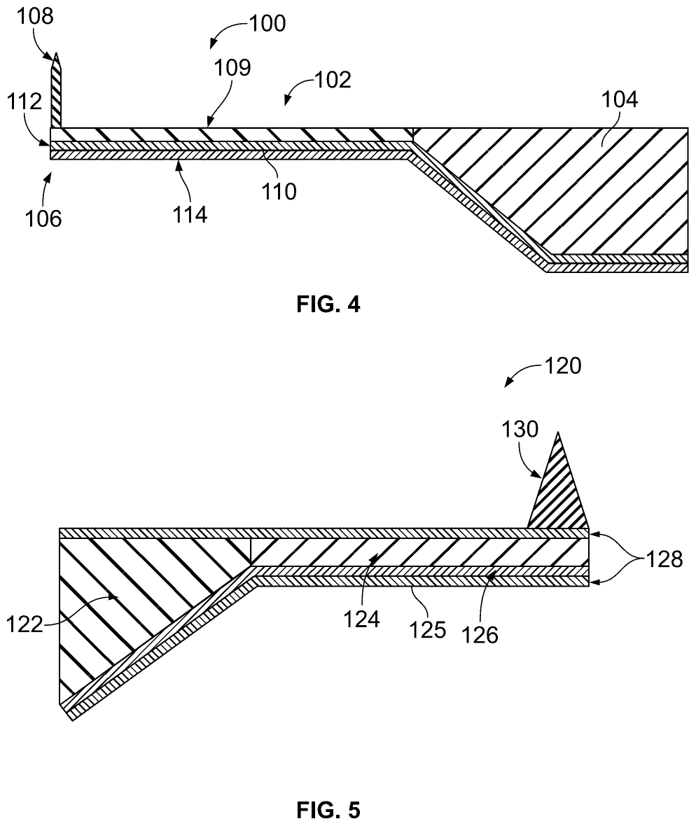

Turning initially to FIG. 4, a schematic probe assembly 100 that employs a passivated metal layer is shown and described. Microfabricated probe assembly 100 includes a cantilever 102 extending from a base 104 (e.g., formed from a stock silicon wafer) and having a distal end 106 supporting an AFM imaging tip 108. Cantilever 102 includes a front side 109 and a backside 110 upon which a metal coating 112 is disposed after formation of the lever. Coating or layer 112 is preferably aluminum given its advantageous properties for optical deflection detection and peak AFM performance. To allow reliable operation in fluid this layer includes a passivation layer 114 disposed thereon, preferably using atomic layer deposition (ALD).

In this regard, thin atomic layer films of silicon oxide or silicon nitride are deposited to passivate the metal coated cantilevers 102. The thickness of the film can be a few nanometers, typically in the range of 1 nm to few hundred nanometers (such as 300 nm) so that this layer will have no appreciable impact on the cantilever dynamics (natural resonance frequency, etc.). The material, length and width of the lever will define the resonance and stiffness of the cantilever 102, selected based on mode of use and application, as understood in the field. Cantilever 102 can be silicon, silicon oxide or any other material used in AFM probe fabrication. In the end, ultrathin (sub nm to ˜10 nm) and continuous passivation is often important to preserve tip sharpness. However, for specific applications where thicker passivation is needed, such as to prevent charge leakage due to tunneling, we can obtain higher thicknesses while ensuring that they are pin hole free, hence the aforementioned wide range.

Notably, passivation can be done on the AFM cantilever with an existing sharp tip (miniscule tip sharpness loss results, typically), or on a tipless cantilever (tip may or may not be added later). In the embodiment shown in FIG. 5, the sharp tip 130 is later deposited or attached, for example, using electron beam deposition (EBD) or CVD deposition processing. Here, a probe assembly 120 includes a base 122 formed using a silicon wafer. A cantilever 124 of assembly 120 extends from base 122 at a proximal end of the lever, and is typically also formed from the silicon wafer. The opposite, distal end of lever 124 will support a tip, with the tip added once other probe processing is complete as described below. A reflective metal film such as aluminum is deposited on a backside 125 of lever 124. Then, an ALD passivation film is deposited on assembly 120. In this case, front side and/or backside passivation films 128 are deposited on assembly 120. Once probe assembly 120 is fabricated in this way (tipless and encapsulated with a passivation layer), a sharp tip 130 may or may not be added to the probe using known techniques. In this way, the sharpness of the probe, critical for many applications, can be maintained.

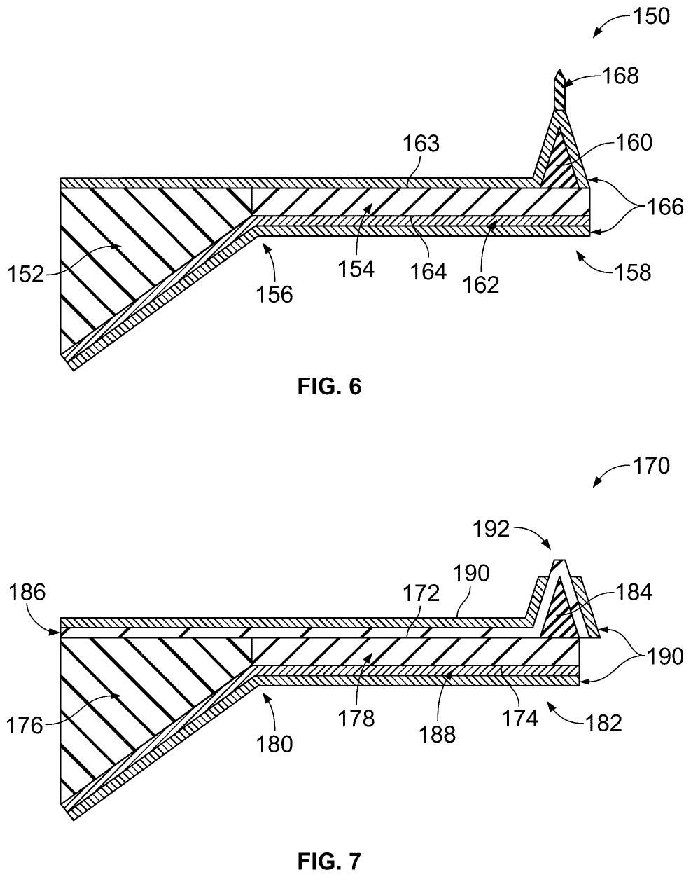

Turning next to FIG. 6, in another alternative, the resultant probe assembly 150 is microfabricated to include a tip prior to passivation. If the AFM cantilever has a sharp tip already defined before passivation, then the tip will be passivated too. This can increase the diameter of the tip in proportion to passivating coating thickness. In applications where a sharp tip is desired, it may be necessary to form another unpassivated tip on top of the existing tip. In most measurements, tips having a height at least several microns are required. Creating such a tip with EBD or CVD is a long and expensive process. Having the passivated tip grown with batch technology for all probes on a wafer provides a main part of the tip height. In this case, the tip deposited with EBD, or other technologies is shorter, so grown faster and cheaper comparing to the embodiment of FIG. 5.

Probe assembly 150 is further processed to include a sharp tip added to the initially microfabricated passivated tip. More particularly, starting with a stock semiconductor wafer a probe body or base 152 is formed with a cantilever 154 having a proximal end 156 extending from base 152. A distal end 158 of lever 154 supports a tip 160, either formed from the wafer or deposited using another material such as silicon nitride, Si₃N₄. Thereafter, a metal film 162 is deposited on the probe assembly backside 164 (opposite front side 163) to make the probe reflective to accommodate an optical deflection detection scheme.

Once probe assembly 150 is formed in this way, the probe assembly is passivated, front and backside preferably, with films 166 using ALD deposition. For applications requiring a sharp tip, as understood in the field, electron beam deposition (EBD) of carbon or any other material may be used to deposit a sharp EBD tip 168 on the passivated tip 160. Tip 160 could alternatively be sharpened, for example, using focused ion beam milling, removing passivation layer 166 from the tip apex, leaving a ring of unpassivated material at the base of conical tip. The goal of having an aluminum coated cantilever suitable for fluid imaging results.

According to a further embodiment shown in FIG. 7, a probe assembly 170 may include metal layers-preferably, metal on both sides, frontside 172 and backside 174, and reflective on one side. Similar to previous embodiments, a silicon (or similar, SOI, etc.) wafer is provided, and using lithography, a base 176 is formed, with a cantilever 178 extending from the base at its proximal end 180. Probe assembly may have a tip 184 extending orthogonally from a distal end 182 of cantilever 178 similar to probe assembly 150 in FIG. 6. However, in this embodiment, metal films 186, 188 are deposited on frontside 172 and backside 174. Metal layers 186, 188 may be the same material or selected according to need, considering application and cantilever dynamics. For example, the backside of the cantilever could be coated with Aluminum for detector laser reflection, whereas the front side of the cantilever could be coated with a different metal film for electrical measurements, cantilever functionalization for biological applications, etc. Cantilever frontside 172 could also be coated with same metal as backside 174 for stress balancing.

Thereafter, probe assembly 170 is passivated with layers 190, as described above, preferably using ALD passivation techniques with films such as silicon oxide or silicon nitride. Once complete, the apex 192 of the tip is exposed by local etching or by focused ion beam (FIB) milling such that the metal coated apex of tip 184 is exposed. This embodiment provides pinhole free passivation across the AFM probe body except the tip apex. This embodiment is particularly useful for microfabricating a nanoelectrode probe (front side metallized with Platinum or Gold, for example) for Scanning Electrochemical Microscopy (SECM). More preferably, the passivation layer could be provided to protect metal corrosion during application in reactive fluids (e.g., biological buffer solution or reactive chemical solution), or to prevent charge leakage during electrical or electrochemical experiments in liquid.

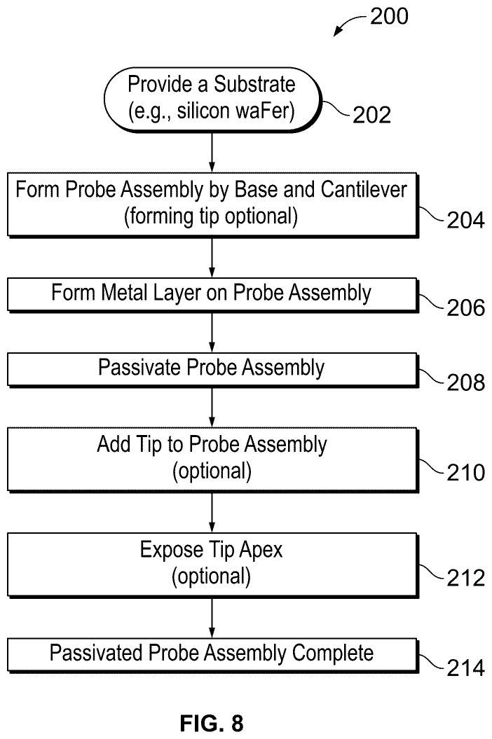

A method 200 of fabricating the passivated probes of the preferred embodiments is shown in FIG. 8. In Step 202 of the microfabrication process, a substrate (e.g., a silicon or SOI wafer) is provided. Using photolithography, a probe assembly base and cantilever extending from the base (diving board) are formed in Step 204. A tip may also be formed, but it is not necessary. Next, in Step 206, a metal layer is formed on the probe assembly. This can be just the backside or the front and back side of the probe assembly. Also, the metal layers may be a stack of metal layers, patterned metal layers, etc.

Method 200 next includes passivating the probe assembly in Step 208. A passivating layer may be formed on the reflective layer using pinhole free atomic layer deposition (ALD), or using PECVD or LPCVD deposition techniques. Passivating layers may be deposited on the frontside or backside of the probe. Moreover, depending on which embodiment described above, a tip of the probe assembly may be added (deposited, for instance) in Step 210. In Step 212, if the tip apex is metalized and passivated, the apex of the tip may be exposed, for example, by local etching or by focused ion beam (FIB) milling. This is the FIG. 7 embodiment which produces a probe assembly that is particularly adopted for use operates as a nanoelectrode suitable for SECM. Finally, in Step 214, the passivated probe assembly is complete.

The process employed in the preferred embodiments uses atomic layer deposited films for pinhole free passivation on metal coated cantilevers. All processing is preferably done at the wafer level for improved performance, lower cost, and consistent user experience. One particularly useful application employs photothermal actuation in liquid using an aluminum reflective coating. Generally, Gold (Au) coated cantilevers are used in photothermal modes. In this case, however, aluminum allows the lever to operate with high absorption efficiency at a broader wavelength range of the laser light. The methods described herein yield ultrathin (sub-nm to ˜10 nm) and continuous/uniform passivation layers which are ideal to preserve tip sharpness. However, for specific applications where thicker passivation is preferred, such as to prevent charge leakage due to tunneling, larger thicknesses can be deposited, while still maintaining pinhole free properties. Hence the passivation layer may have a range from sub-nm to a few hundred nanometers.

In sum, the pinhole free ultra-thin passivating encapsulation of cantilevers coated with lighter metals such as aluminum allows the use of aluminum coated levers in a liquid environment. Aluminum is highly reflective, lighter, cheaper and easy to process, as understood in the field. Advantageously, using a thin reflective coating of aluminum passivated by an ultra-thin, pinhole free passivating layer does not substantially alter cantilever dynamics as compared to a gold or platinum coating, thereby preserving AFM imaging speed. Advantageously, passivating in this way also reduces geometrical constraints on the cantilever, i.e., the need to reduce cantilever length to compensate for the speed loss due to high density noble metal coating. Note that the passivating step of each embodiment may be used on a cantilever/probe assembly coated with a stack of metal films or patterned metal films. In the end, use of AFM probes in a liquid medium where standard aluminum coated cantilevers cannot be used is a primary thrust of the preferred embodiments. However, passivated levers do have advantages in air, as well. For example, by coating with thin ceramic layers such as silicon nitride (Si₃N₄) the preferred embodiments can decrease tip wear, and thus increase probe longevity. Moreover, using ALD to coat thin hydrophobic layers using non-chlorinated hydrophobic precursors can help reduce tip adhesion and thus achieve high resolution imaging in air.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

We claim:

1. A probe assembly for a surface analysis instrument, the probe assembly including:
a substrate defining a probe body of the probe assembly;
a cantilever of the probe assembly extending from the probe body and having a proximal end and a free distal end;
a metal layer disposed on the cantilever to direct electromagnetic energy from a deflection detection apparatus, wherein the metal layer is a chemically non-inert metal; and
a passivating layer disposed on the reflective layer that preserves the metal layer when operating the surface analysis instrument to measure a sample in a reactive fluid.

2. The probe assembly of claim 1, wherein the passivating layer is formed on the metal layer using one of pinhole free atomic layer deposition (ALD), PECVD deposition or LPCVD deposition.

3. The probe assembly of claim 2, further including a tip extending from the distal end of the cantilever.

4. The probe assembly of claim 3, wherein the tip is formed after the passivating layer is deposited on the metal layer.

5. The probe assembly of claim 3, wherein the tip is formed before the passivating layer is deposited on the probe assembly, and a sharp tip is formed to extend from the tip after the passivating layer is deposited on the probe assembly.

6. The probe assembly of claim 5, wherein the sharp tip is formed using electron beam deposition (EBD).

7. The probe assembly of claim 3, wherein the tip is formed before the passivating layer is deposited on the probe assembly, and an apex of the tip is exposed using one of local etching and focused ion beam milling.

8. The probe assembly of claim 1, wherein the reflective metal layer is disposed only on a back side of the probe assembly.

9. The probe assembly of claim 1, wherein the metal layer is disposed on one of the frontside and backside of the probe assembly, and a second metal layer is disposed on the other of the frontside and backside of the probe assembly; and wherein at least one of the first and second metal layers is reflective.

10. The probe assembly of claim 9, wherein the second metal layer is a chemically inert metal.

11. The probe assembly of claim 1, wherein the metal layer is at least one of a stack of reactive metal layers and patterned metal layers.

12. The probe assembly of claim 1, wherein the passivating layer is deposited on at least one of the frontside and the backside of the cantilever.

13. The probe assembly of claim 1, wherein the passivating layer is at least one of Silicon Oxide (SiO₂) and Silicon Nitride (Si₃N₄).

14. A method of manufacturing a probe assembly for a probe-based instrument, the method comprising:
providing a substrate;
forming a probe body of the probe assembly from the substrate and a cantilever of the probe assembly extending from the probe body and having a proximal end and a free distal end;
depositing a metal layer on the cantilever to reflect electromagnetic energy from a deflection detection apparatus, wherein the metal layer is a chemically non-inert metal; and
depositing a passivating layer disposed on the metal layer that preserves the metal layer when operating the surface analysis instrument to measure a sample in a reactive fluid.

15. The method of claim 14, wherein the depositing a passivating layer is performed using pinhole free atomic layer deposition (ALD), and the passivating layer is at least one of Silicon Oxide (SiO₂) and Silicon Nitride (Si₃N₄).

16. The method of claim 14, further comprising forming a tip to extend from the distal end, wherein the tip is formed after the passivating layer is deposited on the metal layer.

17. The method of claim 14, further comprising forming a tip to extend from the distal end of the cantilever, wherein the tip is formed before the passivating layer is deposited on the probe assembly, and a sharp tip is formed to extend from the tip after the passivating layer is deposited.

18. The method of claim 16, further comprising forming a tip to extend from the distal end, wherein the tip is formed before the passivating layer is deposited on the probe assembly, and an apex of the tip is exposed using one of local etching and focused ion beam milling.

19. A probe assembly for a surface analysis instrument, the probe assembly including:
a substrate defining a probe body of the probe assembly;
a cantilever of the probe assembly extending from the probe body and having a proximal end and a free distal end;
a metal layer disposed on the cantilever to reflect light from a coherent light source of a deflection detection apparatus;
a passivating layer disposed on the reflective layer; and
wherein the passivating layer is formed on the metal layer using pinhole free atomic layer deposition (ALD).

20. The probe assembly of claim 19, wherein the passivating layer operates to at least one of a) protect the layer from corrosion when operating the surface analysis instrument in fluid, and b) prevent charge leakage during electrical or electro-chemical experiments in the fluid.
